(19) United States
(12) Patent Application Publication
(10) Pub. No.: US 2014/0116040 A1
(43) Pub. Date: May 1, 2014

(54) TELESCOPIC UNIT WITH ADDITIONAL FUNCTIONALITY

(71) Applicant: Terex Cranes Germany GmbH, Zweibrucken (DE)

(72) Inventor: Rolf Heintz, Langwieden (DE)

(73) Assignee: Terex Cranes Germany GmbH, Zweibrucken (DE)

(21) Appl. No.: 14/064,879

(22) Filed: Oct. 28, 2013

(30) Foreign Application Priority Data
Oct. 29, 2012 (DE) 102012021544.4

(51) Int. Cl. F15B 1/033; F15B 15/16; F15B 1/26

(52) U.S. Cl. CPC F15B 1/033; F15B 1/26; F15B 15/16
USPC 60/416; 60/480

(57) ABSTRACT

A telescopic unit for telescoping means arranged on machines, comprising at least one telescopic hydraulic cylinder and at least one piston arranged axially movable in the cylinder chamber of the telescopic hydraulic cylinder and connected to a piston rod, the bottom side or the piston rod side of the telescopic hydraulic cylinder being configured fixable to a bearing allocated to the machine, and at least one additional hydraulic system being allocated to the free end of the telescopic unit.

### CROSS REFERENCE TO RELATED APPLICATION

This application claims the benefit of German Application DE 102012021544.4, filed Oct. 29, 2012, the contents of which are incorporated herein by reference thereto.

### FIELD OF INVENTION

The present invention relates to a telescopic unit for telescoping means arranged on machines, comprising at least one telescopic hydraulic cylinder and at least one piston arranged as axially movable in the cylinder chamber of the telescopic hydraulic cylinder and connected to a piston rod, the bottom side or the piston rod side of the telescopic hydraulic cylinder being arranged as fixable on a bearing allocated to the machine, and at least one further hydraulic system being arranged on the free end of the telescopic unit which is energized with hydraulic energy via a hydraulic medium.

### BACKGROUND

When machine parts are telescopically connected to one another and these parts are telescoped by means of a telescopic hydraulic cylinder, a hose routing (flange, barrel, etc.), a separate hydraulic system or a hydraulic cylinder with an internal oil connection has to be installed in order to allow for a further function at the exposed end of the telescopic hydraulic cylinder.

In order for a mobile crane with a telescopic boom, for example, to lift large loads with a small counterweight, the boom should be as small as possible. Particularly in the case of large working radii, the weight of the parts of the boom protruding beyond the support base should be kept as small as possible. It is also more advantageous if a lowest possible dead weight has to be moved when a mobile crane is transported.

As a result, single-cylinder telescopic units with a securing and bolting unit—hereinafter designated as SVE—are in most cases installed in such mobile cranes. With this system, a telescopic box is secured to the telescopic hydraulic cylinder by means of the SVE and subsequently unbolted from the surrounding telescopic box. Now, the telescopic hydraulic cylinder extends to the desired length with the telescopic box and bolts the telescopic boxes to one another and unlocks the telescopic hydraulic cylinder from the just moved telescopic box. This procedure is repeated until all telescopic boxes of a telescopic boom have reached their working position. In order to reduce the torque on the boom-side the telescopic hydraulic cylinder is again completely retracted to an initial position. Only now can the extended boom be loaded with a maximum weight.

In these systems, the SVE is located at the exposed end of the telescopic hydraulic cylinder. The hydraulic energy is consequently also required at this point in order to unlock or lock the boxes. In this respect, the disadvantage is that precisely this point is moved back and forth with the telescopic hydraulic cylinder. As a result, the SVE is not directly accessible to hydraulic lines.

At least two approaches to ensure the oil supply, and thus the supply with hydraulic energy, are known from prior art.

Hydraulic hoses routed parallel to the telescopic hydraulic cylinder by means of an energy chain.

In this case, the disadvantage is that the ducts for routing these hydraulic hoses require a lot of space, which is not available, in particular, in smaller telescopic boxes.

A telescopable hydraulic line, which is routed directly through the telescopic hydraulic cylinder in order to route the hydraulic oil to the SVE.

Guiding the oil flow in this way saves space, but also has the disadvantage that such an arrangement is expensive and prone to disruption (the pressure transmission in the penetration tube leads to problems). In case of damage, it can only be remedied with considerable time and concomitant financial expenditure. The entire telescopic hydraulic cylinder has to be removed and dismantled for repairs.

It is therefore an object of the present invention to provide a telescopic unit of the kind described above, with which the above disadvantages can be overcome.

### SUMMARY

In one embodiment, this object is attained by adjusting the piston in the telescopic hydraulic cylinder, the hydraulic energy, which is [generated] by changing the operating status and the resulting difference in the hydraulic pressure of the hydraulic medium, is diverted to and stored in at least a first intermediate reservoir, so as, in this way, to energize the hydraulic system allocated to the free end of the telescopic unit with the hydraulic energy from the first intermediate reservoir, if necessary, and wherein, after consumption of the hydraulic energy stored in the hydraulic medium, the hydraulic medium of the hydraulic system is routed to at least a second intermediate reservoir, and from there again into the telescopic hydraulic cylinder, where it is again energized with hydraulic energy or conveyed to the primary hydraulic circuit of the telescopic unit.

According to an advantageous embodiment of the telescopic unit according to the present invention, the first intermediate reservoir is automatically loaded with the hydraulic medium as soon as the pressure of the hydraulic medium in the telescopic hydraulic cylinder is higher than the pressure of the hydraulic medium in the first intermediate reservoir.

According to another advantageous embodiment, the hydraulic medium is automatically unloaded from the second intermediate reservoir as soon as the pressure of the hydraulic medium in the telescopic hydraulic cylinder is lower than the pressure of the hydraulic medium in the second intermediate reservoir.

It is further provided that the pressures in the intermediate reservoirs are measured with pressure sensors and that the measured pressure data is processed by a computer or sent directly to a control unit.

By way of example, high and low pressures occur in the hydraulic system in case of load changes. In this connection, the intermediate reservoirs act as storage tanks which temporarily store the high and low pressures in the hydraulic system. Depending on the design, the loading and unloading process of the intermediate reservoirs can even take place simultaneously.

The telescopic unit according to the present invention provides that at least two intermediate reservoirs, one for the high pressure and one for the low pressure, which are operatively connected to the hydraulic system (an SVE, for example), are hydraulically connected to the telescopic unit. The number of intermediate reservoirs should, however, not be limited thereto.

The supply of hydraulic energy to the hydraulic system is ensured by the intermediate reservoirs. In this case, the intermediate reservoirs can be configured as bladder reservoirs or piston reservoirs or spring reservoirs. The reservoirs for the high pressure and for the low pressure to be differentiated therefrom can be directly connected to the telescopic hydraulic cylinder via check valves.

In yet another embodiment of the telescopic unit according to the present invention the first intermediate reservoir for the high pressure is automatically filled, or energized via the hydraulic medium, that is, loaded with hydraulic energy, when the hydraulic pressure in the bottom chamber of the telescopic hydraulic cylinder is higher than the pressure in the first intermediate reservoir as such. This can, for example, be the case when telescoping out, with a static load, or when the telescopic hydraulic cylinder is extended up to the stop in the bolted and secured state.

In another advantageous embodiment of the telescopic unit according to the present invention, the hydraulic medium is automatically unloaded from the second intermediate reservoir as soon as the pressure of the hydraulic medium in the telescopic hydraulic cylinder is lower than the pressure of the hydraulic medium in the second intermediate reservoir. This can, for example, be the case when the valve on the bottom side of the telescopic hydraulic cylinder is opened (i.e. the friction will then be higher than the static load), or the telescopic hydraulic cylinder is retracted up to the stop in the bolted and secured state.

In order to ensure the functionality of the hydraulic system—by way of example that of an SVE—the pressures in the intermediate reservoirs can be measured with pressure sensors and processed in a control unit.

In another embodiment of the telescopic unit according to the present invention, depending on the pressure data determined by the pressure sensors and sent to said telescopic unit, [the] control unit and/or the computer activates the telescopic unit in order to load the intermediate reservoirs with hydraulic energy or unload hydraulic energy from them by changing the operating status.

In this connection, it should also be possible that the control unit controls the hydraulic system via the pressure sensors in order to energize the hydraulic system as soon as the control unit in the first intermediate reservoir detects an amount of hydraulic energy which is insufficient to supply the hydraulic system. In this case, the pressure sensors are configured such that they can convert the pressure of the hydraulic medium into a proportional electric signal.

For a better understanding, an X-way Y-chamber circuit is defined in the following as:

X-way is the number of connections to the cylinder chambers of the telescopic hydraulic cylinder via the check valves.

Y-chamber is the number of internal cylinder chambers of the telescopic hydraulic cylinder, where single-chamber represents the bottom side or the rod side. Two-chamber represents the bottom side and the rod side. The normal cylinder connections for driving the cylinder are not counted in this connection.

In another advantageous embodiment of the telescopic unit according to the present invention, the hydraulic system is supplied with the hydraulic medium via the rod side of the telescopic hydraulic cylinder in a hydraulic two-way single-chamber circuit.

In another embodiment, the hydraulic system is supplied with the hydraulic medium via the bottom side by the piston rod of the telescopic hydraulic cylinder in a hydraulic two-way single-chamber circuit.

In a further especially advantageous embodiment of the telescopic unit according to the present invention, the hydraulic system is supplied with the hydraulic medium via the rod side of the telescopic hydraulic cylinder in a hydraulic two-way two-chamber circuit. The oil can also be supplied to the hydraulic system via the bottom side of the telescopic hydraulic cylinder with a hydraulic two-way two-chamber circuit.

Furthermore, in an advantageous embodiment, the hydraulic system is supplied with the hydraulic medium via the rod side or the bottom of the telescopic hydraulic cylinder with a four-way two-chamber circuit.

It is especially advantageous to process the pressure sensor signals detected by means of the pressure sensor in the computer or in the control unit as such, so as to use the determined values to adjust the electric valves (poppet valves), via which loading and unloading of the intermediate reservoirs can be regulated or controlled. Conventional check valves could be replaced thereby. In this way, not only the loading and unloading of the intermediate reservoirs can be controlled, but it is thus also possible to limit the maximum pressure in the intermediate reservoirs. Furthermore, a defined pressure difference (delta-P) can be maintained while loading the intermediate reservoirs. In this way, the output capacity can be defined for the hydraulic system, and no further potential pressure adjustment will be necessary. Instead of the electric valves, hydraulically controlled valves can also be used in another embodiment.

In another especially advantageous embodiment of the telescopic unit according to the present invention, the hydraulic system is supplied with oil via the bottom side and the piston rod side of the telescopic hydraulic cylinder in a hydraulic three-way two-chamber circuit, the hydraulic system being connected to the cylinder tube of the telescopic hydraulic cylinder, and the returning oil being routed only into the bottom side.

According to a further especially advantageous embodiment of the telescopic unit according to the present invention, the oil for the hydraulic system is supplied via the piston rod side and the bottom side of the telescopic hydraulic cylinder in a hydraulic three-way two-chamber circuit, the hydraulic system being connected to the cylinder tube of the telescopic hydraulic cylinder, and the pressure oil being extracted only from the bottom side. It is also possible to extract the pressure oil from the piston rod side.

It is also advantageous if the oil for the hydraulic system is supplied via the piston rod side and the bottom side of the telescopic hydraulic cylinder in a hydraulic three-way two-chamber circuit, the hydraulic system being connected to the piston rod of the telescopic hydraulic cylinder, and the returning oil being routed only into the bottom side. The returning oil could also be routed only into the piston rod side.

The oil supply for the hydraulic system is also possible via the bottom side and the piston rod side of the telescopic hydraulic cylinder in a hydraulic three-way two-chamber circuit, where the hydraulic system is connected to the cylinder tube of the telescopic hydraulic cylinder, and where the returning oil can only be routed into the rod side.

Furthermore, the oil for the hydraulic system can be supplied via the piston rod side and bottom side of the telescopic hydraulic cylinder in a hydraulic three-way two-chamber circuit, where the hydraulic system is connected to the piston rod of the telescopic hydraulic cylinder, and where the returning oil can only be extracted from the rod side.

### BRIEF DESCRIPTION OF THE DRAWINGS

The invention will hereinafter be explained in more detail by means of exemplary embodiments with reference to the attached drawings. The figures show:

FIG. 1 shows a partially cutaway view of a schematic circuit diagram of the telescopic unit according to the present invention with an oil supply for the hydraulic system which is implemented via the piston side of the telescopic hydraulic cylinder in a hydraulic two-way single-chamber circuit;

FIG. 2 shows a partially cutaway view of a schematic circuit diagram of the telescopic unit according to the present invention with an oil supply for the hydraulic system which is implemented via the rod side of the telescopic hydraulic cylinder in a hydraulic two-way single-chamber circuit;

FIG. 3 shows a partially cutaway view of a schematic circuit diagram of the telescopic unit according to the present invention with an oil supply for the hydraulic system which is implemented via the cylinder tube of the telescopic hydraulic cylinder in a hydraulic two-way two-chamber circuit;

FIG. 4 shows a partially cutaway view of the schematic circuit diagram of the telescopic unit according to the present invention with an oil supply for the hydraulic system which is implemented via the rod side of the telescopic hydraulic cylinder in a hydraulic two-way two-chamber circuit;

FIG. 5 shows a partially cutaway view of a schematic circuit diagram of the telescopic unit according to the present invention with an oil supply for the hydraulic system which is implemented via the piston rod side and the bottom side of the telescopic hydraulic cylinder in a hydraulic two-way two-chamber circuit, the hydraulic system being connected to the bottom side of the telescopic hydraulic cylinder;

FIG. 6 shows the schematic circuit diagram of the telescopic unit according to the present invention as shown in FIG. 5, with additional intermediate reservoirs and pressure sensors;

FIG. 7 shows the schematic circuit diagram of the telescopic unit according to the present invention as shown in FIG. 5, the hydraulic system being connected to the rod side of the telescopic cylinder;

FIG. 8 shows the schematic circuit diagram of the telescopic unit according to the present invention as shown in FIG. 3, with rotated loading or unloading connections at the cylinder tube;

FIG. 9 shows the schematic circuit diagram of the telescopic unit according to the present invention as shown in FIG. 4, with rotated loading or unloading connections on the piston rod side;

FIG. 10 shows the schematic circuit diagram of the telescopic unit according to the present invention as shown in FIG. 1, the oil being supplied here from the rod side;

FIG. 11 shows the schematic circuit diagram of the telescopic unit according to the present invention as shown in FIG. 2, where the connection is here too implemented via the piston rod, however not to the bottom side of the telescopic cylinder, but rather to its rod side;

FIG. 12 shows a partially cut view of a schematic circuit diagram of the telescopic unit according to the present invention with an oil supply for the hydraulic system which is implemented via the piston rod side and the bottom side of the telescopic hydraulic cylinder in a hydraulic “three-way two-chamber” circuit; the hydraulic system is connected to the cylinder tube of the telescopic hydraulic cylinder, wherein, in contrast to FIG. 5, the returning oil is routed only into the bottom side;

FIG. 13 shows the schematic circuit diagram of the telescopic unit according to the present invention as shown in FIG. 5, the returning oil being here routed only into the rod side;

FIG. 14 shows a partially cutaway view of a schematic circuit diagram of the telescopic unit according to the present invention with an oil supply for the hydraulic system which is implemented via the piston rod side and the bottom side of the telescopic hydraulic cylinder in a hydraulic “three-way two-chamber circuit;” the hydraulic system is connected to the cylinder tube of the telescopic cylinder, where in contrast to FIG. 5, the pressure oil is extracted only from the bottom side;

FIG. 15 shows the schematic circuit diagram of the telescopic unit according to the present invention as shown in FIG. 5, the pressure oil being here extracted only from the rod side;

FIG. 16 shows a partially cutaway view of a schematic circuit diagram of the telescopic unit according to the present invention with an oil supply for the hydraulic system which is implemented via the piston rod side and the bottom side of the telescopic hydraulic cylinder in a hydraulic “three-way two-chamber” circuit; the hydraulic system is connected to the piston rod of the telescopic hydraulic cylinder, where in contrast to FIG. 7, the returning oil is only routed into the bottom side;

FIG. 17 shows the schematic circuit diagram of the telescopic unit according to the present invention as shown in FIG. 7, the returning oil being here routed only into the rod side;

FIG. 18 shows a partially cutaway view of a schematic circuit diagram of the telescopic unit according to the present invention with an oil supply for the hydraulic system which is implemented via the piston rod side and the bottom side of the telescopic hydraulic cylinder in a hydraulic “three-way two-chamber circuit;” the hydraulic system is connected to the piston rod of the telescopic cylinder, where in contrast to FIG. 7, the pressure oil is extracted only from the bottom side; and

FIG. 19 shows the schematic circuit diagram of the telescopic unit according to the present invention as shown in FIG. 7, the pressure oil being here extracted only from the bottom side.

### DESCRIPTION OF THE EMBODIMENTS

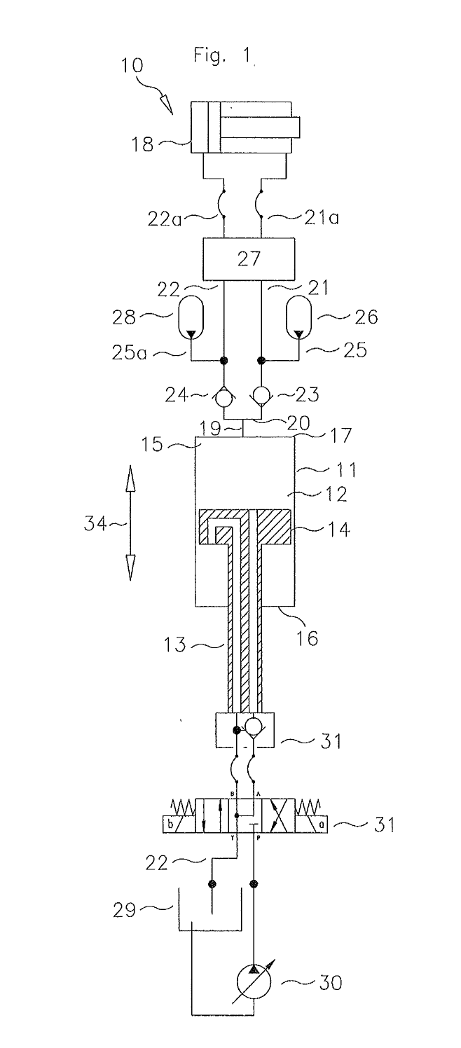

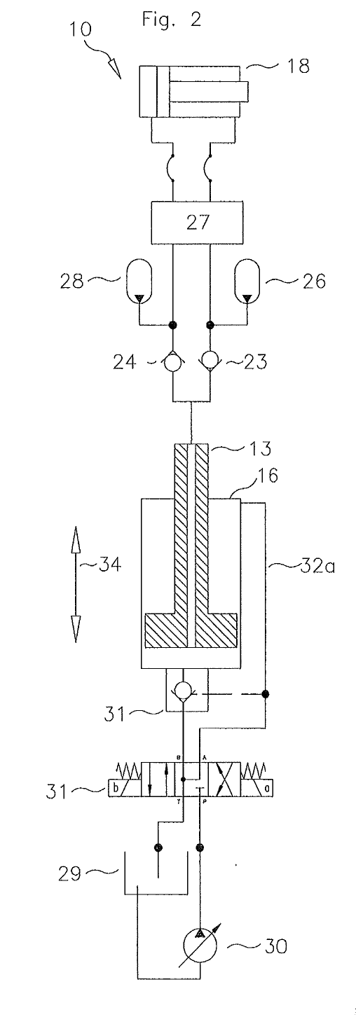

As shown in FIG. 1 and in FIG. 2, the telescopic unit 10 essentially consisting of at least one telescopic hydraulic cylinder 11 and at least one piston 14 arranged as axially movable in the cylinder tube 12 of the telescopic hydraulic cylinder 11 and connected to a piston rod 13. The bottom side 15 or the piston rod side 16 of the telescopic hydraulic cylinder 11 is, in this case, attached to a bearing (not shown) allocated to a machine or to a part of a machine (not shown). At least one hydraulic system 18 is allocated to the free end 17 of the telescopic unit 10.

The hydraulic system 18 is configured as an SVE in this embodiment. In other embodiments, the hydraulic system 18 can, for example, be designed for mounting or removing working equipment. The bolting and unbolting of working equipment, for example equipment for rotating, closing or opening appliances, such as, for example, grabs, grips, loading troughs and lifting platforms, is conceivable. For this purpose, a hydraulic medium is energized with hydraulic energy and routed to the hydraulic system 18.

The hydraulic system 18 is, as shown in FIG. 1, connected to the bottom side 15 of the telescopic hydraulic cylinder 11 via a line 19. The line 19 has a bifurcation 20 which divides the line 19 into a feed line 21 and a return line 22. Correspondingly configured valves 23 and 24 are provided so that the hydraulic medium can only flow in a predetermined direction in the feed line 21 and, respectively, in the return line 22. The valves 23 and 24 are configured as check valves in this embodiment.

In the following, the path of the hydraulic medium in the feed line 21 downstream of the check valve 23 in the direction of the hydraulic system 18 will first be described. The check valve 23 prevents the hydraulic medium from accidentally flowing from the feed line 21 back to the bottom side 15 of the telescopic hydraulic cylinder 11. A bypass 25 is allocated to the feed line 21, which is connected to a first intermediate reservoir 26. In this embodiment, the intermediate reservoir 26 is configured as a bladder reservoir.

The changing operating statuses generate pressure differences in the telescopic hydraulic cylinder 11 and consequently also in the feed line 21. These pressure differences occur, for example, when driving loads or when driving against bolt holes or end stops, or the like. Even with unchanged load, different hydraulic pressures are generated in the telescopic hydraulic cylinder 11 owing to the different bottom to ring area ratios. These pressure differences represent an energy potential which can be used for additional work. The higher pressures in the hydraulic fluid are now routed via the bypass 25 into the intermediate reservoir 26 and stored for the time being.

The feed line 21 is connected to a control unit 27. The control unit 27 is in turn connected to the hydraulic system 18 via the feed line 21a. The control unit 27 detects and regulates the required hydraulic energy and makes it available from the intermediate reservoir 26 to the hydraulic system 18 if necessary.

Once the task has been accomplished, the “expanded” hydraulic medium is now routed out of the hydraulic system 18 into a return line 22a. The backflow of the hydraulic medium is regulated by the control unit 27 connected to the return line 22a. The expanded hydraulic medium is routed into a second intermediate reservoir 28 containing a hydraulic medium having a lower pressure compared to the first intermediate reservoir 26 via a bypass 26 and temporarily stored. The control unit 27 prevents the hydraulic medium from flowing back through the control unit 27 and on into the hydraulic system 18. The check valve 24 is connected to the feed line 19, from where the hydraulic medium is pushed back into the cylinder chamber 12 as the occasion arises.

The hydraulic system 18, the control unit 27, as well as the intermediate reservoirs 26, 28 along with the return lines 19, 21, 21a and 22, 22a and the check valves 23 and 24 are configured as movable together with the telescopic hydraulic cylinder 11. The hydraulic system 18 can, in this case, be mounted in a floating manner.

The hydraulic medium is stored in a storage tank 29, from where it is made available to the telescopic hydraulic cylinder 11 by means of a hydraulic pump 30 via adjustment and control means 31.

FIG. 1 shows a first embodiment of the telescopic unit 10 according to the present invention, in which the hydraulic system 18 is supplied with a hydraulic medium at the cylinder tube 12 of the telescopic hydraulic cylinder 11 from the bottom side 15 with a hydraulic two-way single-chamber circuit.

FIG. 2 shows a second embodiment of the telescopic unit 10 according to the present invention, in which the hydraulic system 18 is supplied with the hydraulic medium through the piston rod 13 with the bottom side of the telescopic hydraulic cylinder 11 by means of a hydraulic two-way single-chamber circuit. The hydraulic medium can be routed via a return line 32a from the piston rod side 16 to the adjustment and control means 31, from where it is again pumped into the storage tank 29.

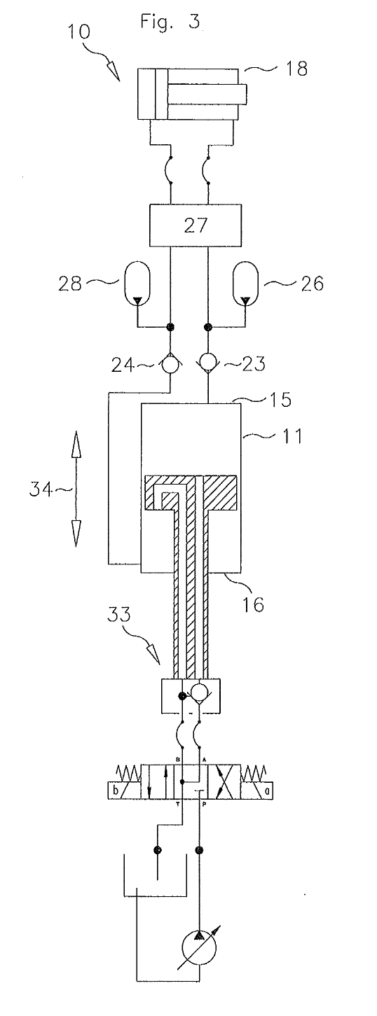

FIG. 3 shows a further embodiment of the telescopic unit 10 according to the present invention. In this case, the hydraulic system 18 is supplied with a hydraulic medium via the cylinder tube 12 of the bottom side 15 of the telescopic hydraulic cylinder 11 by means of a hydraulic two-way single-chamber circuit. In this connection, the expanded hydraulic medium is routed from the intermediate reservoir 28 via the bypass 25a through the valve 24 via a return line 32 into the piston rod side 16 of the telescopic hydraulic cylinder 11.

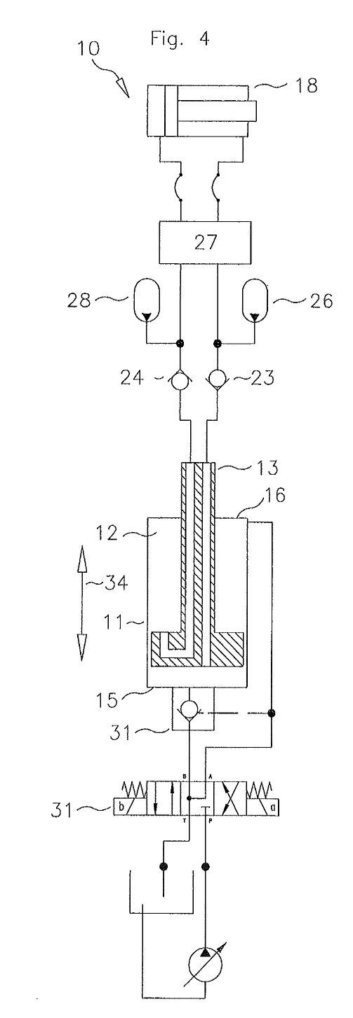

FIG. 4 likewise shows an embodiment of the telescopic unit 10 according to the present invention. The hydraulic system 18 is likewise supplied, as shown in FIG. 2, through the piston rod 13 to the bottom side and the rod side 15 and 16 of the telescopic hydraulic cylinder 11. In contrast to FIG. 2, the embodiment is configured, as in FIG. 3, as a hydraulic two-way two-chamber circuit.

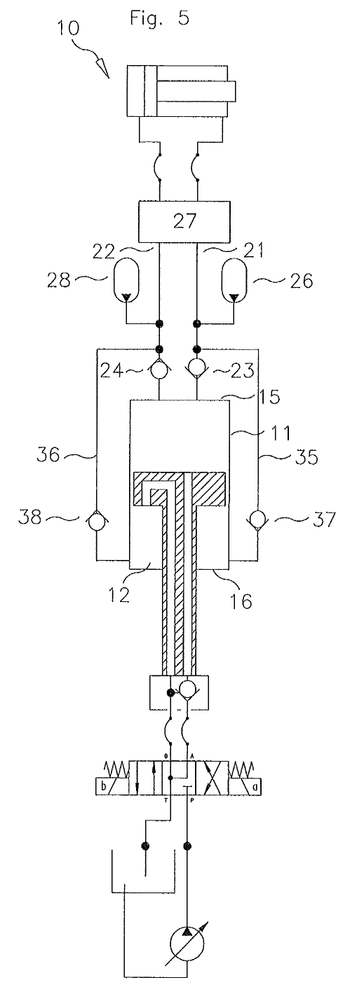

FIG. 5 shows a further embodiment of the telescopic unit 10 according to the present invention, in which high pressure and low pressure are connected by means of a four-way two-chamber circuit. For this purpose, in this embodiment, the feed line 21 and the return line 22 are connected to the bottom side 15 of the telescopic hydraulic cylinder 11 via check valves. The feed or return of the hydraulic medium is controlled by the valves 23, 24. Another line 35, 36 is allocated to the feed and return lines 21, 22 between the reservoirs 26, 28 and the valves 23, 24, where said line 35, 36 controls the feed line or return line of the hydraulic medium to the piston rod side 16 by means of additional valves 37, 38 allocated thereto.

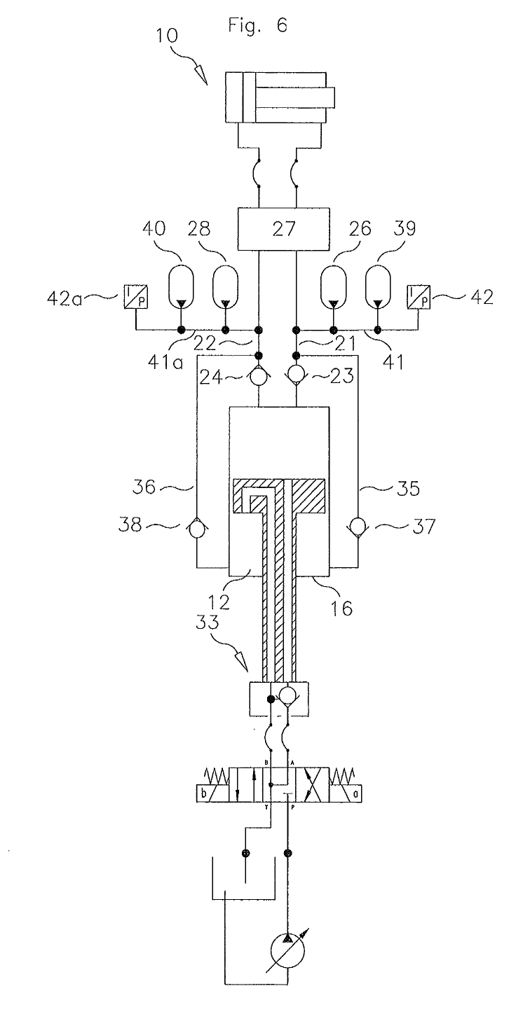

FIG. 6 likewise is an embodiment of the telescopic unit 10 according to the present invention with which high pressure and low pressure are connected by means of a four-way two-chamber circuit, as described in FIG. 5. The intermediate reservoirs 39 and 40 are provided in addition to the intermediate reservoirs 26 and 28, said intermediate reservoirs 39 and 40 being connected to a pressure sensor 42, 42a via a bypass line 41 and 41a. The bypass line 41 and 41a is connected to the feed line 21 and, respectively, return line 22, which in turn is connected to the line 35 and 36 on the rod side 33 and, respectively, to the piston rod side 16 of the cylinder chamber 12. The pressure sensor 42, 42a detects the pressure drop or pressure build-up in the intermediate reservoirs 26, 28 and 39, 40 and converts the hydraulic pressure into electric signals. This [sic] signals ensures the balance of hydraulic medium, or as the case may be pressure, in the event that . . . [TN: missing word] are used in an electric control unit (not shown) to release the control unit 27 and load or unload the intermediate reservoirs 26, 28 and 29 40 [sic] by telescoping.

In another embodiment, which is not shown, the check valves 23, 24 and 37, 38 are replaced by electric poppet valves. These electric poppet valves are then also controlled by an electric control unit, taking into account the signals of the pressure sensor 42, 42a.

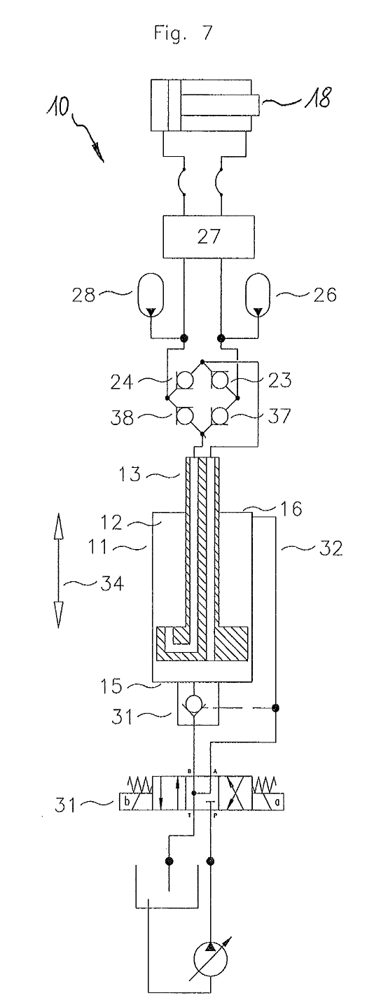

FIG. 7 likewise shows an embodiment of the telescopic unit 10 according to the present invention. The hydraulic system 18 is likewise supplied with a hydraulic medium, as shown in FIG. 4, to the bottom side and the rod side 15, 16 of the telescopic hydraulic cylinder 11 through the piston rod 13. In contrast to the drawing in FIG. 4, this embodiment is configured, as in FIG. 5, as a hydraulic four-way-two-chamber circuit.

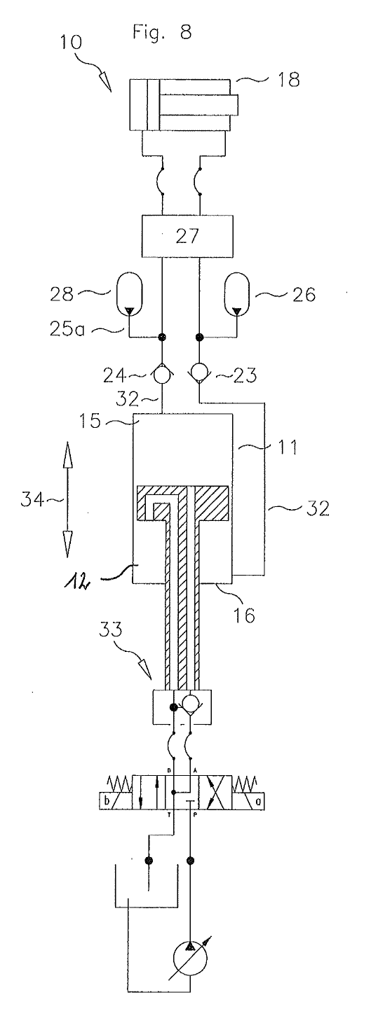

FIG. 8 shows a further embodiment of the telescopic unit 10 according to the present invention analogously to the drawing in FIG. 3. In this case, however, the hydraulic medium is supplied to the hydraulic system 18 from the piston rod side 16 of the telescopic hydraulic cylinder 11 via the cylinder tube 12.

In this connection, the expanded hydraulic medium is routed from the intermediate reservoir 28 via the bypass 25a through the valve 24 into the bottom side 15 of the telescopic hydraulic cylinder 11 via the return line 32.

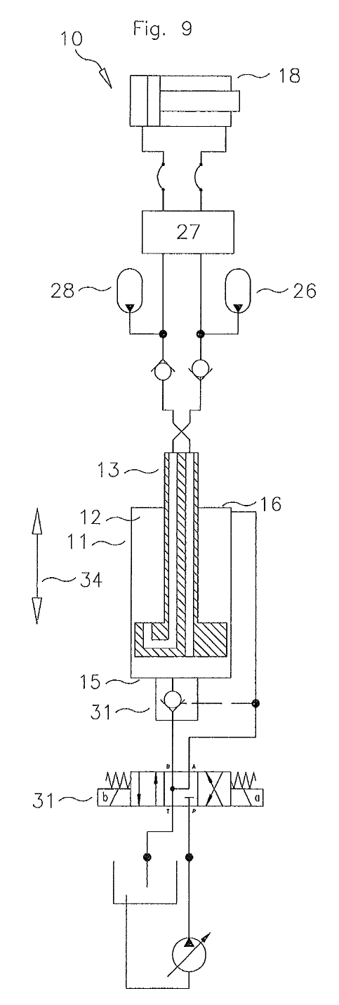

FIG. 9 likewise shows an embodiment of the telescopic unit 10 according to the present invention. The hydraulic system 18 is likewise supplied, as shown in FIG. 4, through the piston rod 13 to the bottom and the rod side 15 and 16 of the telescopic hydraulic cylinder 11. The embodiment is configured, as in FIG. 4, as a hydraulic two-way-two-chamber circuit. But in contrast to FIG. 4, the loading/unloading lines are, in this case, connected rotated to the piston rod 13. The hydraulic medium is thus pushed into the intermediate reservoir 26 from the piston rod side and the recirculation to the bottom side 15 takes place from the intermediate reservoir 28.

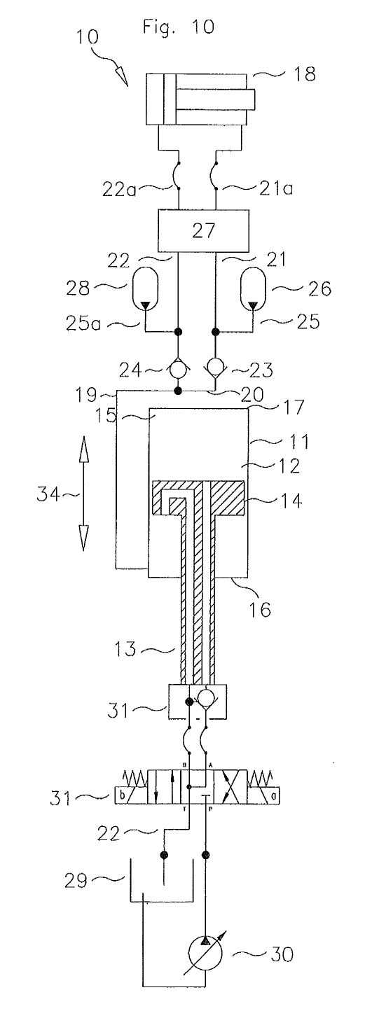

FIG. 10 shows a further embodiment of the telescopic unit 10 according to the present invention, in which the hydraulic system 18 is supplied with the hydraulic medium at the cylinder tube 12 from the piston rod side 16 of the telescopic hydraulic cylinder 11 by means of a hydraulic two-way single-chamber circuit.

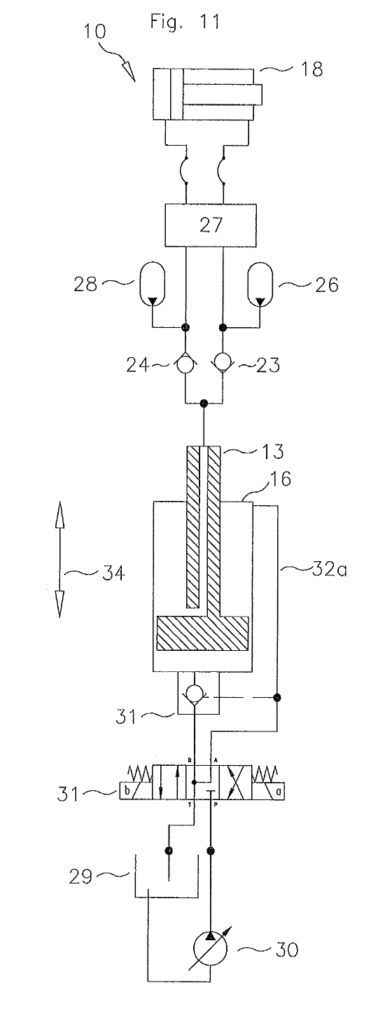

FIG. 11 shows a further embodiment of the telescopic unit 10 according to the present invention, in which the hydraulic medium is supplied to the hydraulic system 18 by means of the piston rod 13 into the piston rod side 16 of the telescopic hydraulic cylinder 11 by means of a hydraulic two-way single-chamber circuit.

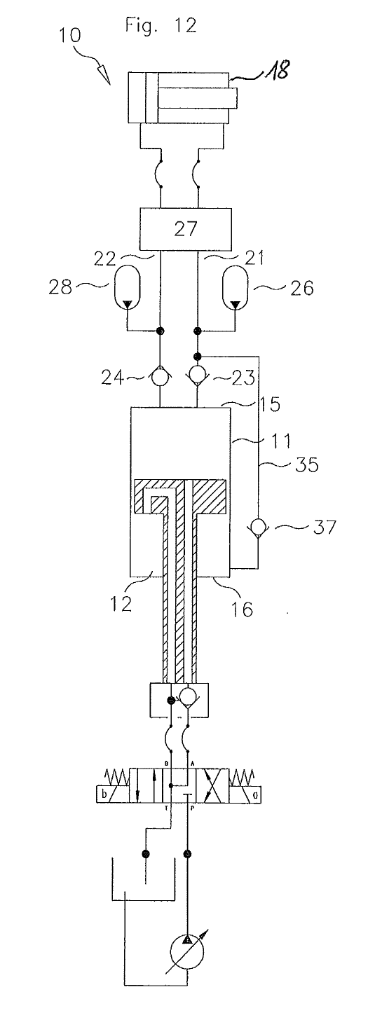

FIG. 12 shows a further embodiment of the telescopic unit 10 according to the present invention, in which the hydraulic system 18 is supplied with the hydraulic medium analogously to FIG. 5. But the return line 36 and the valve 38 of FIG. 5 have been omitted in this case. This embodiment is thus a “three-way two-chamber circuit.

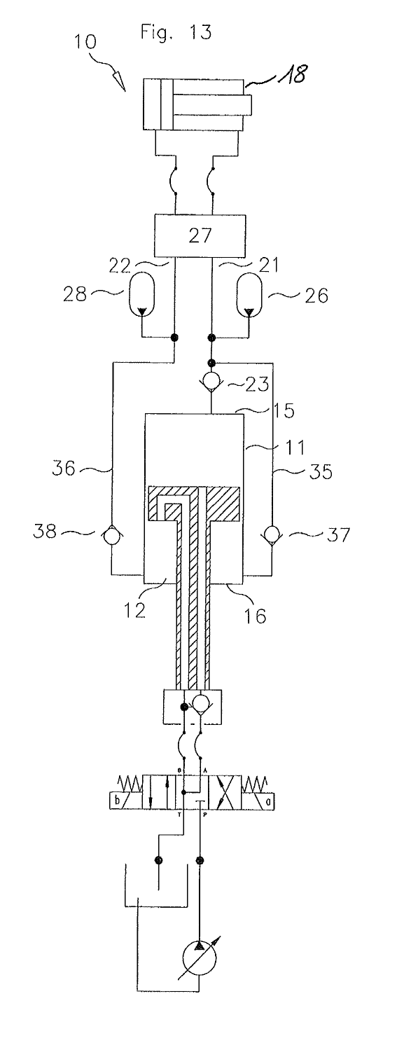

FIG. 13 shows a further embodiment of the telescopic unit 10 according to the present invention, in which the hydraulic system 18 is supplied with the hydraulic medium analogously to FIG. 5. But the return line 36 and the valve 38 have been kept in this case, but the valve 24 has been omitted. This is also a three-way two-chamber circuit.

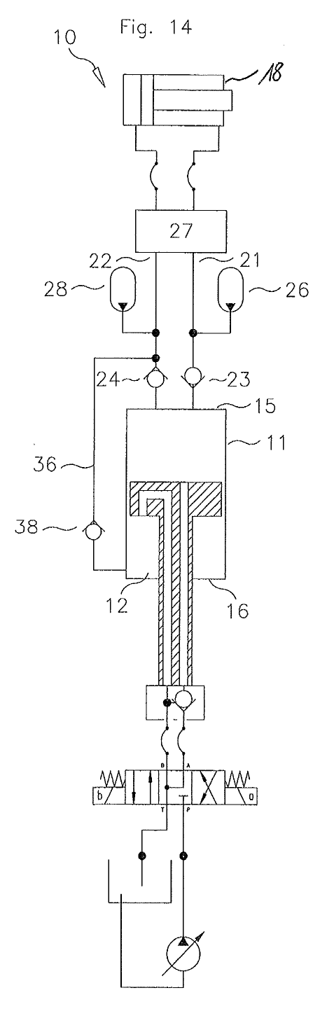

FIG. 14 shows a further embodiment of the telescopic unit 10 according to the present invention, in which the hydraulic system 18 is supplied with the hydraulic medium analogously to FIG. 5. In this embodiment, the intermediate reservoir 26 is only supplied with pressure from the bottom side 15 via the valve 23. The line 35 and the valve 37 have been omitted. This embodiment is likewise a three-way two-chamber circuit.

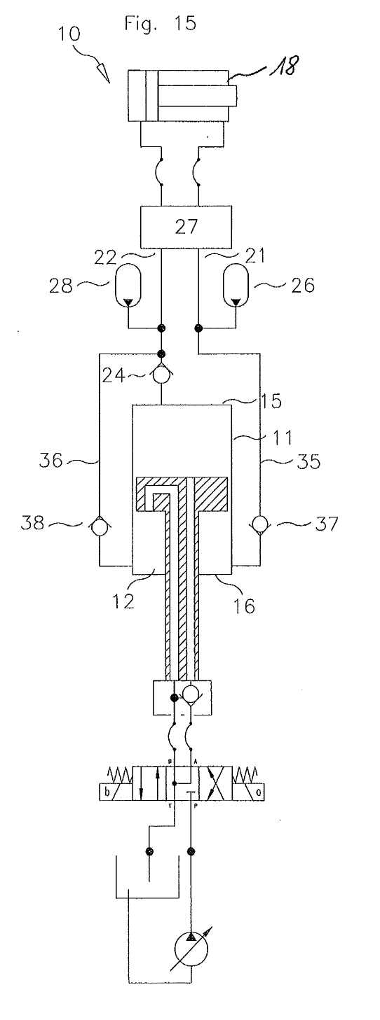

FIG. 15 shows a further embodiment of the telescopic unit 10 according to the present invention, in which the hydraulic system 18 is supplied with the hydraulic medium analogously to FIG. 5. Now, the intermediate reservoir 26 is only supplied with pressure from the piston rod side 16 via the valve 37 and the line 35. The valve 23 has been omitted. This embodiment is again a three-way two-chamber circuit.

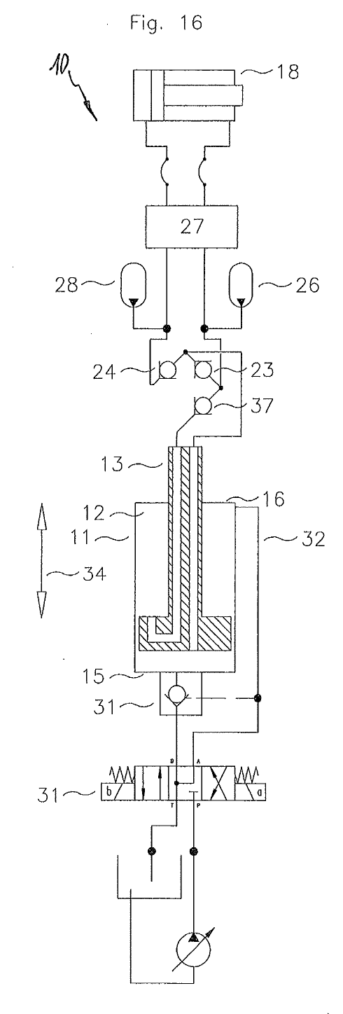

FIG. 16 shows a further embodiment of the telescopic unit 10 according to the present invention, in which the hydraulic system 18 is supplied with the hydraulic medium analogously to FIG. 7, that is, through the piston rod 13. In this variant, the medium can only flow back from the intermediate reservoir 26 into the bottom side 15 via the valve 24. The valve 38 has not been installed. In this case, it is also a three-way two-chamber circuit.

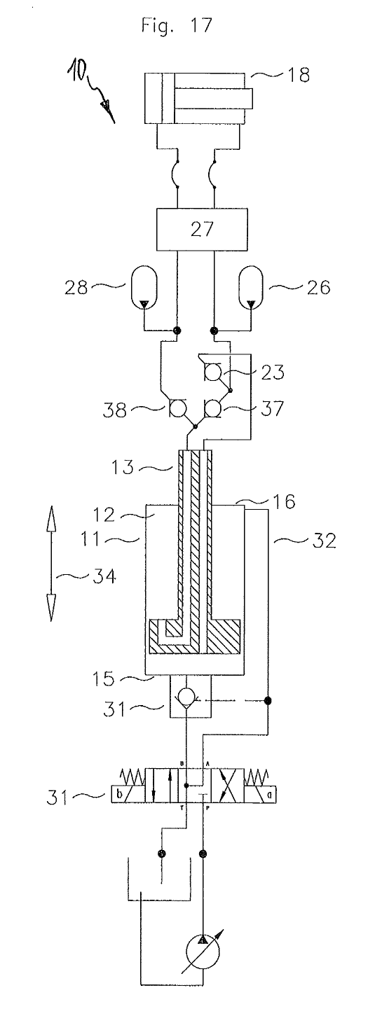

FIG. 17 shows a further embodiment of the telescopic unit 10 according to the present invention, in which the hydraulic system 18 is supplied with the hydraulic medium analogously to FIG. 7. In this variant, the medium can only flow back from the intermediate reservoir 26 into the rod side 16 via the valve 38. The valve 24 has not been installed here. This is likewise a three-way two-chamber circuit.

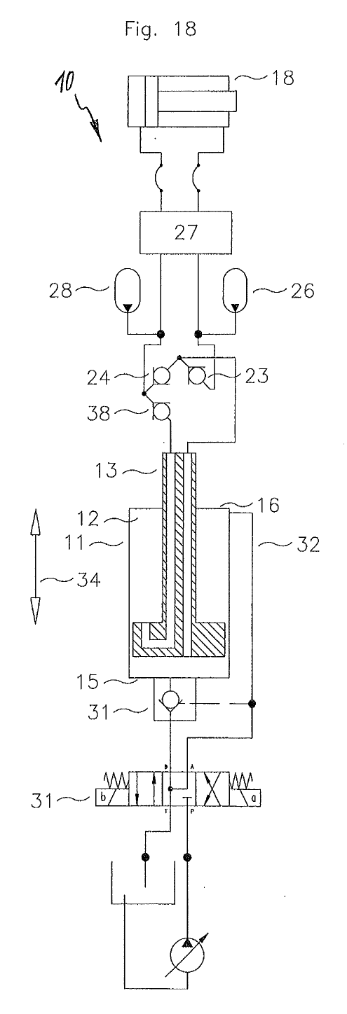

FIG. 18 shows a further embodiment of the telescopic unit 10 according to the present invention, in which the hydraulic system 18 is supplied with the hydraulic medium analogously to FIG. 7. In this embodiment, the intermediate reservoir 26 is only supplied with pressure from the bottom side 15 via the valve 23. The valve 37 has not been installed here. It is likewise a three-way two-chamber circuit.

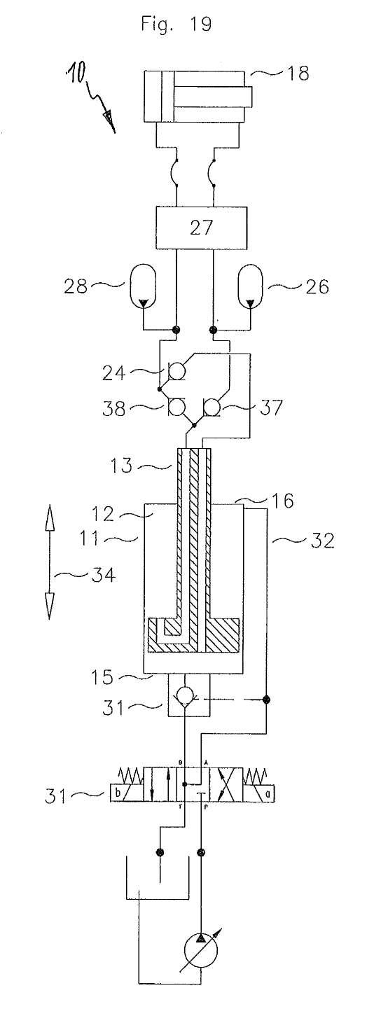

FIG. 19 shows a further embodiment of the telescopic unit 10 according to the present invention, in which the hydraulic system 18 is supplied with the hydraulic medium analogously to FIG. 7. In this circuit type, the pressure is only supplied to the intermediate reservoir 26 via the valve 37 and only from the rod side 16. There is no load connection to the bottom side 15. Here, it is also a three-way two-chamber circuit.

1. A telescopic unit for telescoping means arranged on machines, comprising at least one telescopic hydraulic cylinder and at least one piston arranged axially movable in the cylinder chamber of the telescopic hydraulic cylinder and connected to a piston rod, the bottom side of the piston rod side of the telescopic hydraulic cylinder being configured fixable to a bearing allocated to the machine, and at least one additional hydraulic system being allocated to the free end of the telescopic unit, said hydraulic system being energized with hydraulic energy by a hydraulic medium, wherein by adjusting the piston in the telescopic hydraulic cylinder, the hydraulic energy, which is generated by changing the operating status and the resulting difference in hydraulic pressure, is diverted to and stored in at least a first intermediate reservoir, so that the hydraulic system allocated to the free end of the telescopic unit is thus energized with the hydraulic energy from the first intermediate reservoir if necessary, and where, after consumption of the hydraulic energy stored in the hydraulic medium, said hydraulic medium of the hydraulic system is routed into at least a second intermediate reservoir, and from there again into the telescopic hydraulic cylinder, where it is again energized with hydraulic energy or conveyed to the primary hydraulic circuit of the telescopic unit.

2. The telescopic unit according to claim 1, wherein the first intermediate reservoir is automatically loaded with the hydraulic medium as soon as the pressure of the hydraulic medium is higher in the telescopic hydraulic cylinder than the pressure of the hydraulic medium in the first intermediate reservoir.

3. The telescopic unit according to claim 1, wherein the hydraulic medium is automatically unloaded from the second intermediate reservoir as soon as the pressure of the hydraulic medium in the telescopic hydraulic cylinder is lower than the pressure of the hydraulic medium in the second intermediate reservoir.

4. A telescopic unit according to claim 1, wherein the pressures in the intermediate reservoirs are measured with pressure sensors, and that the measured pressure data is processed by a computer or directly sent to a control unit.

5. A telescopic unit according to claim 4, wherein the intermediate reservoirs are configured as bladder reservoirs, or as piston reservoirs, or as spring reservoirs.

6. A telescopic unit according to claim 4, wherein depending on the data determined and transmitted by the pressure sensors to said telescopic unit, the control unit or the computer activates the telescopic unit in order to load the intermediate reservoirs with hydraulic energy or unload hydraulic energy from them by changing the operating status.

7. A telescopic unit according to claim 6, wherein by processing the data provided by the pressure sensors, the control unit or the computer of the hydraulic system only energizes the hydraulic system when the pressure difference between the first intermediate reservoir and the second intermediate reservoir has reached a predefined minimum value.

8. A telescopic unit according to claim 7, wherein the pressure sensors convert the pressure of the hydraulic medium into a proportional electric signal.

9. The telescopic unit according to claim 7, wherein the hydraulic system is supplied with the hydraulic medium from the bottom side through the piston rod of the telescopic hydraulic cylinder in a hydraulic two-way single-chamber circuit.

10. A telescopic unit according to claim 7, wherein the hydraulic system is supplied with the hydraulic medium from the bottom side at the cylinder tube of the telescopic hydraulic cylinder in a hydraulic two-way single-chamber circuit.

11. A telescopic unit according to claim 7, wherein the hydraulic medium is supplied to the hydraulic system from the bottom side and the rod side of the telescopic hydraulic cylinder via the piston rod with a two-way single-chamber circuit.

12. A telescopic unit according to claim 7, wherein the hydraulic system is supplied with the hydraulic medium from the bottom side and the rod side at the cylinder tube of the telescopic hydraulic cylinder by means of a hydraulic two-way single-chamber circuit.

13. A telescopic unit according to claim 7, wherein the hydraulic system is supplied with the hydraulic medium from the bottom side and the rod side by the piston rod of the telescopic hydraulic cylinder by means of a hydraulic four-way two-chamber circuit.

14. The telescopic unit according to claim 7, wherein the hydraulic system is supplied with the hydraulic medium from the bottom and the rod side at the cylinder tube of the telescopic hydraulic cylinder by means of a four-way two-chamber circuit.

15. The telescopic unit according to claim 7, wherein the hydraulic system is supplied with the hydraulic medium from the rod side through the piston rod of the telescopic hydraulic cylinder in a hydraulic two-way single-chamber circuit.

16. A telescopic unit according to claim 7, wherein the hydraulic system is supplied with the hydraulic medium from the rod side at the cylinder tube of the telescopic hydraulic cylinder in a hydraulic two-way single-chamber circuit.

17. The telescopic unit according to claim 4, wherein the pressure sensor signals measured by the pressure sensors are transmitted to the computer or to the control unit, and that they are used to control the valves for the loading and unloading of the intermediate reservoirs.

18. The telescopic unit according to claim 17, wherein the valves are electric poppet valves, or hydraulically controlled valves or mechanical check valves.

19. The telescopic unit according to claim 7, wherein the oil for the hydraulic system is supplied via the bottom and the piston rod side of the telescopic hydraulic cylinder in a hydraulic “three-way two-chamber circuit,” the hydraulic system being connected to the cylinder tube of the telescopic hydraulic cylinder, and the returning oil being routed only into the bottom side.

20. The telescopic unit according to claim 7, wherein the oil for the hydraulic system is supplied via the bottom and the piston rod side of the telescopic hydraulic cylinder in a hydraulic three-way two-chamber circuit, the hydraulic system being connected to the cylinder tube of the telescopic hydraulic cylinder, and the returning oil only being extracted from the bottom side.

21. The telescopic unit according to claim 20, wherein the pressure oil is only extracted from the piston rod side.

22. The telescopic unit according to claim 7, wherein the oil for the hydraulic system is supplied via the bottom side and piston rod side of the telescopic hydraulic cylinder in a hydraulic three-way two-chamber circuit, the hydraulic system being connected to the piston rod of the telescopic hydraulic cylinder, and the returning oil only being routed into the bottom side.

23. The telescopic unit according to claim 22, wherein the pressure oil is only routed into the piston rod side.

24. The telescopic unit according to claim 7, wherein the oil for the hydraulic system is supplied via the piston rod side and the bottom side of the telescopic hydraulic cylinder in a hydraulic three-way two-chamber circuit, the hydraulic system being connected to the piston rod of the telescopic hydraulic cylinder, and the returning oil only being extracted from the bottom side.

25. The telescopic unit according to claim 7, wherein the oil for the hydraulic system is supplied via the bottom side and the piston rod side of the telescopic hydraulic cylinder in a hydraulic “three-way single-chamber circuit, the hydraulic system being connected to the cylinder tube of the telescopic hydraulic cylinder and the returning oil only being routed into the rod side.

26. The telescopic unit according to claim 7, wherein the oil for the hydraulic system is supplied via the piston rod side and the bottom side of the telescopic hydraulic cylinder in a hydraulic three-way two-chamber circuit, the hydraulic system being connected to the piston rod of the telescopic hydraulic cylinder, and the returning oil only being extracted from the rod side.
